(19) United States
(12) Patent Application Publication
(10) Pub. No.: US 2023/0099226 A1
(43) Pub. Date: Mar. 30, 2023

(54) FUEL CELL SYSTEM

(71) Applicant: TOYOTA JIDOSHA KABUSHIKI KAISHA, Toyota-shi (JP)

(72) Inventor: Yoshiaki NAGANUMA, Toyota-shi (JP)

(73) Assignee: TOYOTA JIDOSHA KABUSHIKI KAISHA, Toyota-shi (JP)

(21) Appl. No.: 17/933,998

(22) Filed: Sep. 21, 2022

(30) Foreign Application Priority Data
Sep. 22, 2021 (JP) 2021-154675

(51) Int. Cl. H01M 8/04858; H01M 8/04537; H01M 8/249

(52) U.S. Cl. CPC H01M 8/0488; H01M 8/04559; H01M 8/04619; H01M 8/0494; H01M 8/249; H01M 8/04567

(57) ABSTRACT

A fuel cell system may include: a fuel cell unit connected to an output terminal; a battery unit connected to the fuel cell unit in parallel: and a controller configured to control the fuel cell unit to maintain an output voltage of the fuel cell unit at an idling voltage which is higher than zero and lower than an output voltage of the battery unit when a target output power is lower than an output power lower limit set for the fuel cell unit.

### CROSS-REFERENCE TO RELATED APPLICATIONS

This application claims priority based on Japanese patent application No. 2021-154675 filed on Sep. 22, 2021, the entire contents of which are hereby incorporated by reference into the present application.

### TECHNICAL FIELD

The art disclosed herein relates to a fuel cell system configured to be used as a power source.

### BACKGROUND

International Publication WO2017/010069 describes a fuel cell system in which a plurality of fuel cell stacks is connected to an output terminal in parallel. A controller of the fuel cell system drives the minimum number of fuel cell stacks required to obtain a target output power. When one or more of the fuel cell stacks need not be driven, the fuel cell stack(s) of which total power generating time is long are stopped.

### SUMMARY

Fuel cell stacks degrade due to repetitive stop (“stop” means a state in which output voltage is zero) and activation. The present disclosure provides a fuel cell system that can mitigate the degradation.

A fuel cell system disclosed herein comprises a fuel cell unit connected to an output terminal, a battery unit connected to the fuel cell unit in parallel, and a controller. The fuel cell unit includes a fuel cell stack. The fuel cell unit may comprise a step-up converter configured to step up the output voltage of the fuel cell stack. The controller is configured to control the fuel cell unit to maintain an output voltage of the fuel cell unit at a predetermined idling voltage which is higher than zero and lower than an output voltage of the battery unit when target output power of the fuel cell system is lower than an output power lower limit set for the fuel cell unit. For example, by adjusting an amount of oxygen (air) to be supplied to the fuel cell stack, the output voltage of the fuel cell unit can be reduced to the idling voltage.

In the fuel cell system disclosed herein. when the target output power is low, the output voltage of the fuel cell unit is set to a voltage lower than the output voltage of the battery unit. Electric current is not outputted from the fuel cell unit (fuel cell stack) and power of the battery unit alone is outputted from the output terminal. Further, the controller is configured to maintain the output voltage of the fuel cell unit at the idling voltage. The fuel cell unit (fuel cell stack) is maintained in the state not stopped but not outputting power. Since the fuel cell unit (fuel cell stack) is not stopped although it is not outputting power, degradation is mitigated.

An example of the idling voltage is a voltage equal to or higher than a value defined by multiplying a maintenance voltage of a single cell in a fuel cell stack by the number of cells in the fuel cell stack. The maintenance voltage is an output voltage at which the degradation tend not to progress, and is predetermined based on physical characteristics of the single cell. When the target output power is low, the fuel cell unit does not output power but maintains the output voltage of the fuel cell unit at the idling voltage. By maintaining the output voltage of the fuel cell unit at the idling voltage lower than the output voltage of the battery unit, the degradation of the fuel cell stack can be mitigated.

The fuel cell unit may comprise a step-up converter configured to step up the output voltage of the fuel cell stack. In this case, when the target output power is higher than the output power lower limit, the controller may be configured to: control the fuel cell unit so that the output power of the fuel cell unit becomes equal to or higher than the target output power; and control the step-up converter so that the output voltage of the fuel cell unit exceeds the output voltage of the battery unit. Power is not outputted from the battery unit, and the output power of the fuel cell unit is outputted from the output terminal.

The fuel cell unit may comprise a plurality of fuel cell stacks (a first fuel cell stack and a second fuel cell stack) connected in parallel. A first output power lower limit may be set for the first fuel cell stack; and a second output power lower limit may be set for the second fuel cell stack. In this case, the controller may be configured to perform any one of the following three processes. (1) When the target output power is higher than the first output power lower limit and lower than a total of the first and second output power lower limits, the controller may control the first fuel cell stack so that the output power of the first fuel cell stack becomes equal to or higher than the target output power. The controller may control the second fuel cell stack to maintain the output voltage of the second fuel cell stack at a second idling voltage which is higher than zero and lower than the output voltage of the battery unit. (2) When the target output power is higher than the total of the first and second output power lower limits, the controller may control the first and second fuel cell stacks so that the output power of the first fuel cell stack exceeds the first output power lower limit, the output power of the second fuel cell stack exceeds the second output power lower limit, and a total output power of the first and second fuel cell stacks becomes equal to or higher than the target output power. (3) When the target output power is lower than each of the first and second output power lower limits, the controller may control the first fuel cell stack to maintain the output voltage of the first fuel cell stack at a first idling voltage which is higher than zero and lower than the output voltage of the battery unit. The controller may control the second fuel cell stack to maintain the output voltage of the second fuel cell unit at the second idling voltage. In any of the above cases. the degradation of the fuel stack can be mitigated by maintaining the voltages of the first/second fuel cell stacks at predetermined values (first/second idling voltages) that are lower than the battery voltage.

While the output voltages of the first/second fuel cell stacks are maintained at the first/second idling voltages, power of the battery unit is outputted from the output terminal.

Details of the technique disclosed herein and further developments will be described in “DETAILED DESCRIPTION”.

### BRIEF DESCRIPTION OF DRAWINGS

FIG. 1 illustrates a block diagram of a fuel cell system of a first embodiment.

FIG. 2 illustrates a graph indicating a relationship between an output current and an output voltage of a fuel cell unit.

FIG. 3 illustrates a flowchart of a fuel cell unit control (first embodiment).

FIG. 4 illustrates a block diagram of a fuel cell system of a second embodiment.

FIG. 5 illustrates a flowchart of a fuel cell unit control (second embodiment).

FIG. 6 illustrates a block diagram of a fuel cell system of a third embodiment.

FIG. 7 illustrates a flowchart of a fuel cell unit control (third embodiment).

FIG. 8 illustrates a flowchart of the fuel cell unit control (continuation of FIG. 7).

FIG. 9 illustrates a flowchart of the fuel cell unit control (continuation of FIG. 8).

### DETAILED DESCRIPTION

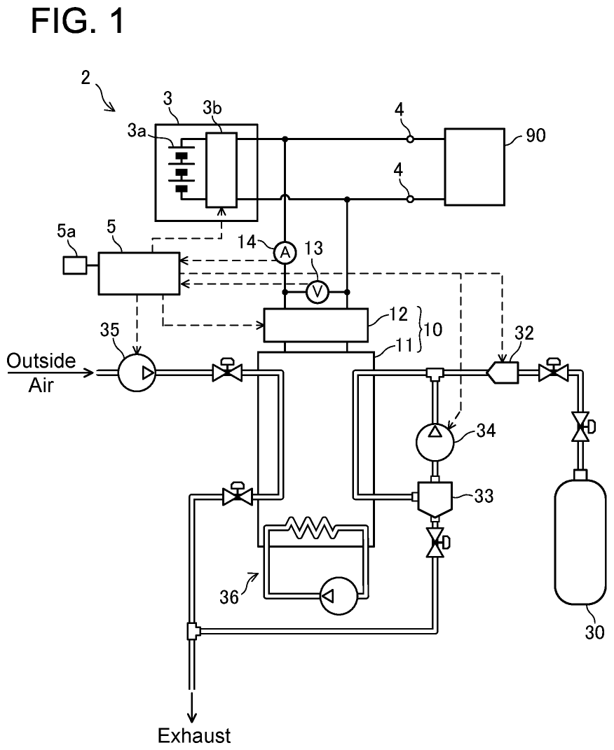

(First Embodiment) A fuel cell system 2 of a first embodiment will be described with reference to figures. FIG. 1 illustrates a block diagram of the fuel cell system 2. The fuel cell system 2 includes a fuel cell unit 10. a battery unit 3, output terminals 4 and a controller 5. The fuel cell system 2 is configured to output power from the output terminals 4. In the configuration of FIG. 1. an electric device 90 is connected to the output terminals 4, and the fuel cell system 2 is configured to supply power to the electric device 90. Broken lines in FIG. 1 indicate communication lines. Hereafter. “fuel cell” is described in short as “FC” for convenience of explanation. The fuel cell unit 10 will be described as an FC unit 10, and a fuel cell stack 11 will be described as an FC stack 11.

An operation board 5a is connected to the controller 5. The operation board 5a includes switches for setting power (target output power) to be outputted from the output terminals 4. A user of the fuel cell system 2 operates the switches of the operation board 5a and inputs the target output power to the controller 5. The FC unit 10 and the battery unit 3 are connected to the output terminals 4 in parallel, and the controller 5 is configured to control the FC unit 10 so that power outputted from the output terminals 4 matches the target output power.

The battery unit 3 includes a battery 3a and a voltage converter 3b. The voltage converter 3b includes a step-up function of stepping up an output voltage of the battery 3a and outputting the same to the output terminals 4 and a step-down function of stepping down the output voltage of the FC unit 10 and supplying the same to the battery 3a. The voltage converter 3b having such functions is referred to as a bidirectional DC-DC converter. The controller 5 is configured to control the voltage converter 3b and adjust the output voltage of the battery unit 3. When remaining charge in the battery 3a is low, the controller 5 controls the FC unit 10 and the voltage converter 3b, and charges the battery 3a using the output power of the FC unit 10.

The FC unit 10 includes a FC stack 11 in which a plurality of single cells is connected in series and a step-up converter 12 configured to step up an output voltage of the FC stack 11. As is well-known, the FC stack 11 (plurality of single cells) generates electricity by reaction between hydrogen and oxygen.

A fuel tank 30 and various electric devices for operating the FC unit 10 are connected to the FC unit 10. The electric devices for operating the FC unit 10 may be referred to as auxiliary devices. The auxiliary devices include, for example, an injector 32 configured to supply fuel (hydrogen) to the FC stack 11, a gas-liquid separator 33 configured to separate residual gas that has passed through the FC stack 11 into a residual hydrogen gas and water, a pump 34 configured to return the residual hydrogen gas to the FC stack 11, an air compressor 35 configured to supply oxygen (air) to the FC stack 11, a cooler 36 configured to cool the FC stack 11, and the like. In addition to the above, a plurality of pressure sensors and valves accompanies the FC unit 10, however, explanations thereof will be omitted. The controller 5 can adjust the output power of the FC stack 11 by controlling the auxiliary devices and adjusting amounts of hydrogen gas and oxygen (air) supplied to the FC stack 11. Further, the controller 5 can adjust the output voltage of the FC unit 10 by controlling the step-up converter 12.

The output voltage and the output current of the FC unit 10 are measured by a voltage sensor 13 and a current sensor 14, respectively. Measurement values of the voltage sensor 13 and the current sensor 14 are sent to the controller 5. The controller 5 obtains the output voltage and the output current of the FC unit 10 from the measurement values of the voltage sensor 13 and the current sensor 14, respectively. The output power of the FC unit 10 is defined by multiplying the output voltage by the output current.

The FC system 2 of the embodiment includes the battery unit 3. If the battery unit 3 can supply a required power, it is desirable not to use the FC unit 10 (the FC stack 11). However, it is known that degradation of the FC stack 11 progresses if it is frequently and repeatedly stopped and activated. For this reason, when the required power (the target output power) is low, the controller 5 controls the FC unit 10 as follows. That is, when the target output power is low, the controller 5 controls the FC unit 10 to maintain the output voltage at the idling voltage without the FC unit 10 outputting power to the output terminals 4. As described above, “control the FC unit 10” means one or both of (1) adjusting the amount of oxygen or hydrogen (or both of oxygen and hydrogen) to be supplied to the FC stack 11 and (2) controlling a step-up ratio of the step-up converter 12.

The idling voltage is set to a value defined by multiplying a maintenance voltage of each single cell in the FC stack 11 by the number of the single cells in the FC stack 11. Here, the maintenance voltage of the single cell means a voltage which the single cell can stably output while suppressing progression of degradation of the single cell. The maintenance voltage is predetermined in accordance with the physics characteristics of the single cell. When the output voltage of the FC unit 10 (the FC stack 11) is at the idling voltage, degradation of each of the single cells included in the FC unit 10 can be mitigated.

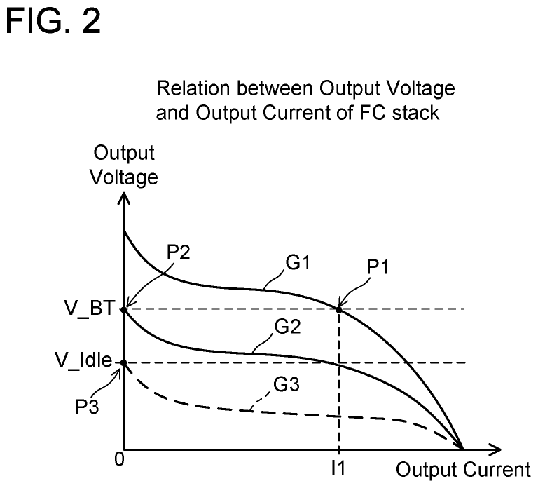

Here, the relationship between the current/voltage characteristics of the FC stack 11 and the idling voltage will be explained referring to FIG. 2. FIG. 2 is a graph indicating the output current and the output voltage of the FC stack 11 in a horizontal line and a vertical line, respectively. For clearer understanding, the step-up ratio of the step-up converter 12 is set to 1. In other words. the output voltage of the FC stack 11 is equal to the output voltage of the FC unit 10.

As is well-known, in the FC stack, when the more amounts of oxygen and hydrogen are supplied, the graph goes more upward. In the example of FIG. 2. the graph G1 indicates the state in which the supply amounts of oxygen and hydrogen are the highest. Further. the FC stack tends to have a lower voltage when its output current is larger. When an internal resistance of a load connected to the FC stack is small, current which flows from the FC stack to the load increases and the voltage decreases. When the internal resistance of the load is large or when the output terminals of the FC stack are opened, current is not outputted from the FC stack while the voltage at the output terminals of the FC stack becomes the highest. When the output current is zero. reaction of hydrogen and oxygen does not take place inside the FC stack and the FC stack is maintained in a charged state.

The FC stack 11 (FC unit 10) and the battery unit 3 are connected to the output terminals 4 in parallel. Consequently, when the output voltage of the FC stack 11 is higher than a Voltage V_BT of the battery unit 3, power is outputted from the FC stack 11. On the other hand, when the output voltage of the FC stack 11 is lower than the voltage V_BT, power is not outputted from the FC stack 11. When the FC stack 11 have characteristics as indicated in the graph G1, an operation point of the FC stack 11 is maintained at a point P1. Here, when supply of oxygen to the FC stack 11 is stopped, the graph gradually moves downward. In the FC stack 11, reaction may stop at a point where the output current is zero and the output voltage is V_BT (graph G2). In other words, the FC stack 11 is maintained at an operation point (point P2 in FIG. 2) where power (current) is not outputted but the output voltage is equal to the voltage (battery voltage V_BT) of the battery unit 3.

The idling voltage V_Idle to be described is set to a value lower than the battery voltage V_BT. When the FC stack 11 (FC unit 10) is controlled to match the output voltage of the FC stack 11 with the idling voltage V_Idle, the FC stack 11 exhibits the characteristics as in the graph G3, and reaction stops at a point P3. At the point P3, since the voltage V_Idle of the FC stack 11 is lower than the battery voltage V_BT, power (current) is not outputted from the FC stack 11 (FC unit 10) while the voltage V_Idle is maintained.

In the embodiment, the target output of the fuel cell system 2 is indicated by a unit of power (target output power), however, the target output of the fuel cell system 2 may be indicated using a unit of current (target output current). The target output current is indicated by a current obtained when the output voltage of the FC unit 10 becomes equal to the battery voltage V_BT (current I1 in the case of graph G1). The target power output is indicated by a product of the current I1 obtained when the output voltage of the FC unit 10 becomes equal to the battery voltage V_BT and the battery voltage V_BT (I1×V_BT).

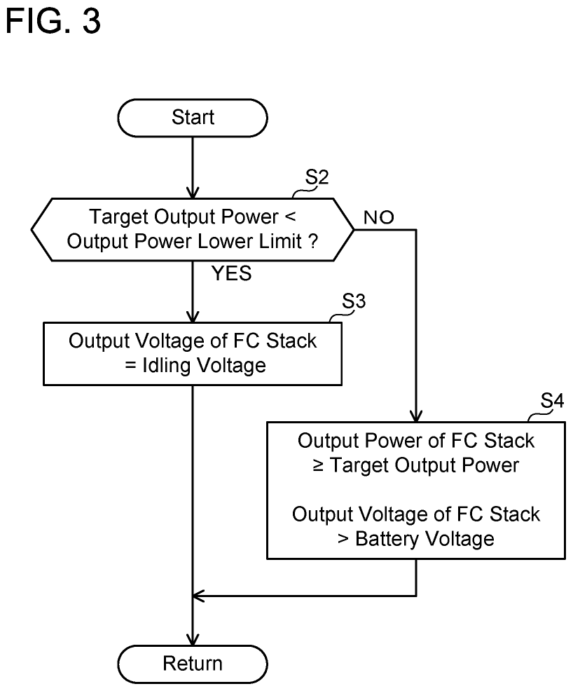

A flowchart of a process executed by the controller 5 is illustrated in FIG. 3. In the following explanations and in FIG. 3, the output voltage of the FC unit 10 may be referred to as an FC voltage and a voltage of the battery unit 3 may be referred to as a battery voltage.

As described above, the target output power is set by the user. The controller 5 compares the target output power with an output power lower limit (step S2). The output power lower limit is preset for the FC unit 10.

When the target output power is higher than the output power lower limit (step S2: NO), the controller 5 controls the FC unit 10 so that the output power of the FC unit 10 becomes equal to or higher than the target output power (step S4). Simultaneously, the controller 5 controls the step-up converter 12 so that the FC voltage (output voltage of the step-up converter 12) exceeds the battery voltage. Since the FC voltage exceeds the battery voltage, the output power of the FC unit 10 is outputted from the output terminals 4. The battery 3a of the battery unit 3 is a secondary battery that can be recharged, and when the battery 3a is not fully charged, the battery 3a is charged using a part of the output power of the FC unit 10.

When the battery 3a is fully charged, the controller 5 controls the FC unit 10 to match the output power of the FC unit 10 with the target output power. In this case, all the output power of the FC unit 10 is outputted from the output terminals 4, and is then supplied to the electric device 90.

When the target output power is lower than the output power lower limit in step S2 (step S2: YES), the controller 5 controls the FC unit 10 to match the FC voltage with the idling voltage. At this time, the controller 5 controls the step-up converter 12 so that the step-up ratio is 1. The FC voltage (output voltage of the FC unit 10) becomes equal to the voltage of the FC stack 1. In other words, the voltage of the FC stack 11 is maintained at the idling voltage.

As described above, the idling voltage is set to a value defined by multiplying the maintenance voltage of the single cell in the FC stack 11 by the number of single cells included in the FC stack 11. Further, the idling voltage is lower than the battery voltage. Therefore, when the FC voltage is maintained at the idling voltage, power is not outputted from the FC unit 10, and output power of the battery unit 3 is outputted from the output terminals 4. In other words, power is supplied to the electric device 90 not from the FC unit 10 but from the battery unit 3.

As described above, the voltages of the plurality of single cells can be maintained low (however, the voltage of each single cell is not zero) by maintaining the FC voltage (output voltage of the FC stack 11) at the idling voltage. by which degradation of the FC stack 11 can be mitigated.

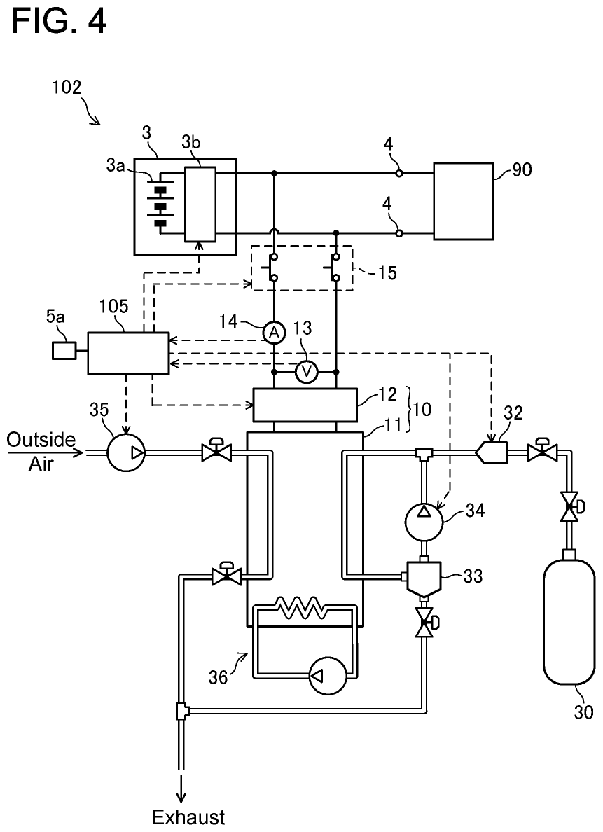

(Second Embodiment) FIG. 4 illustrates a block diagram of a fuel cell system 102 of a second embodiment. The fuel cell system 102 is different from the fuel cell system 2 of the first embodiment only in that FC relay 15 is disposed between the FC unit 10 and the output terminals 4. Explanations of the configuration of the fuel cell system 102 other than the FC relay 15 will be omitted. When the FC relay 15 is opened, the FC unit 10 is electrically separated from the output terminals 4. Even when the FC relay 15 is opened, electrical connection between the battery unit 3 and the output terminals 4 is maintained.

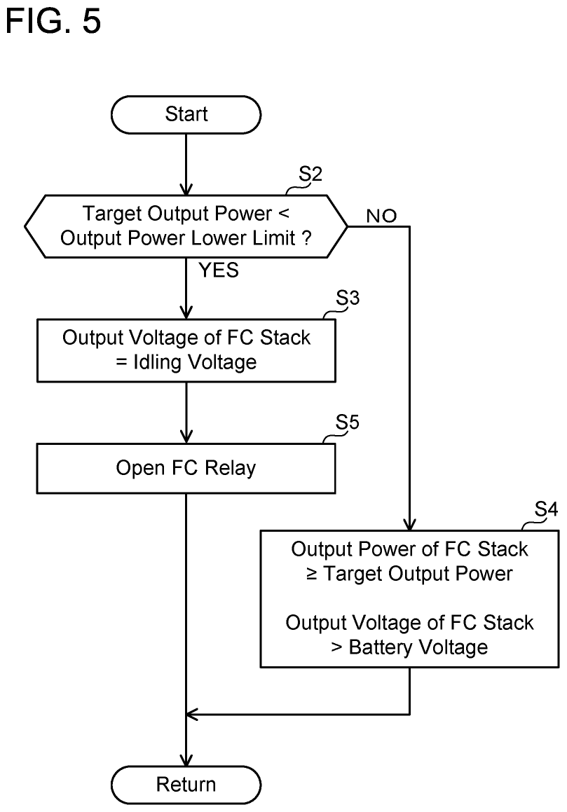

FIG. 5 illustrates a flowchart of a process executed by a controller 105 of the fuel cell system 102. Steps S2, S3, S4 are the same as the flowchart of FIG. 3. In FIG. 5. step S5 is added after step S3. In other words, when the target output power is lower than the output power lower limit, the controller 105 maintains the FC voltage at the idling voltage and then opens the FC relay 15 (step S3, S5). In step S3, the controller 105 drives the step-up converter 12 (output voltage of the step-up converter 12>battery voltage). and outputs the power of the FC stack 11 to the battery unit 3 until the output voltage of the FC stack 11 decreases to the idling voltage. In other words, the controller 105 pumps out power from the FC stack 11 and sends it to the battery unit 3. The controller 105 stops the step-up converter 12 when the output voltage of the FC stack 11 has decreased to the idling voltage, and opens the FC relay 15 (Step S5). When the step-up converter 12 is stopped, the step-up ratio of the step-up converter 12 becomes 1. At this point, the output voltage of the FC unit 10 becomes equal to the output voltage of the FC stack 11. In other words, the FC voltage (output voltage of the FC unit 10) becomes equal to the idling voltage. By opening the FC relay 15 and electrically separating the FC unit 10 from the output terminals 4, it is ensured that power is not outputted from the FC unit 10. Since power is not outputted from the FC unit 10, the output voltage of the FC unit 10 stabilizes.

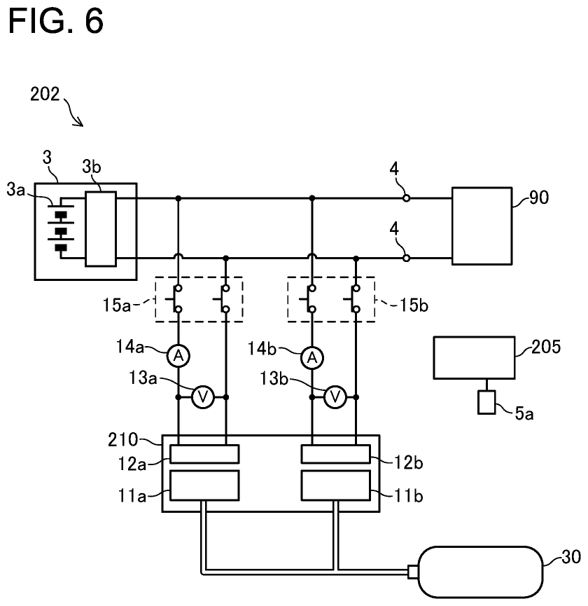

(Third Embodiment) FIG. 6 illustrates a block diagram of a fuel cell system 202 of a third embodiment. An FC unit 210 of the fuel cell system 202 includes two FC stacks (a first FC stack 11a and a second FC stack 11b). The two FC stacks 11a, 11b are connected to the output terminals 4 in parallel along with the battery unit 3. A step-up converter 12a is connected to an output terminal of the first FC stack 11a and a step-up converter 12b is connected to an output terminal of the second FC stack 11b. The FC stacks 11a, 11b are each the same as the FC stack 11 of the first embodiment, and the step-up converters 12a, 12b are each the same as the step-up converter 12 of the first embodiment. Fuel gas (hydrogen gas) is supplied to the two FC stacks 11a, 11b from the same fuel tank 30. In FIG. 6, illustrations of auxiliary devices for the FC stacks, such as injectors, air-gas separators, pumps, and air compressors are omitted.

An output voltage and on output current of the FC stack 11a (11b) are measured by a voltage sensor 13a (13b) and a current sensor 14a (14b), respectively. Measurement values of the voltage sensor 13a (13b) and the current sensor 14a (14b) are transmitted to a controller 205. In FIG. 6, illustrations of communication lines are omitted. From the measurement values of the voltage sensor 13a (13b) and the current sensor 14a (14b), the controller 205 can obtain the output voltage, the output current, the output power of the FC stack 11a (11b).

The operation board 5a is connected to a controller 205, and a user uses the operation board 5a to input power (target output power) to be outputted from the output terminal 4 to the controller 205. The controller 205 controls the FC unit 210 (the FC stacks 11a, 11b) so that the power outputted from the output terminals 4 matches the target output power.

The FC stack 11a (11b) is connected to the output terminals 4 via FC relay 15a (15b). When the controller 205 opens the FC relay 15a (15b), the FC stack 11a (11b) is electrically separated from the output terminals 4. Hereafter, the FC relay 15a may be referred to as first FC relay 15a and the FC relay 15b may be referred to as second FC relay 15b.

An output power lower limit is set for each of the FC stacks 11a. 11b. The output power lower limit of the first FC stack 11a will be referred to as a first output power lower limit, and the output power lower limit of the second FC stack 11b will be referred to as a second output power lower limit. The first output power lower limit and the second output power lower limit may be the same or different. For convenience of explanation, the first output power lower limit is assumed to be lower than or equal to the second output power lower limit.

An idling voltage is set for each of the FC stacks 11a. 11b. When the output voltage of the FC stack 11a (11b) is maintained at its idling voltage, degradation of the plurality of single cells included in the FC stack 11a (11b) can be mitigated. The idling voltage for the first FC stack 11a will be referred to as a first idling voltage, and the idling voltage for the second FC stack 11b will be referred to as a second idling voltage. The first idling voltage and the second idling voltage may be the same or different. Both the first and second idling voltages are higher than zero and lower than the voltage of the battery unit 3.

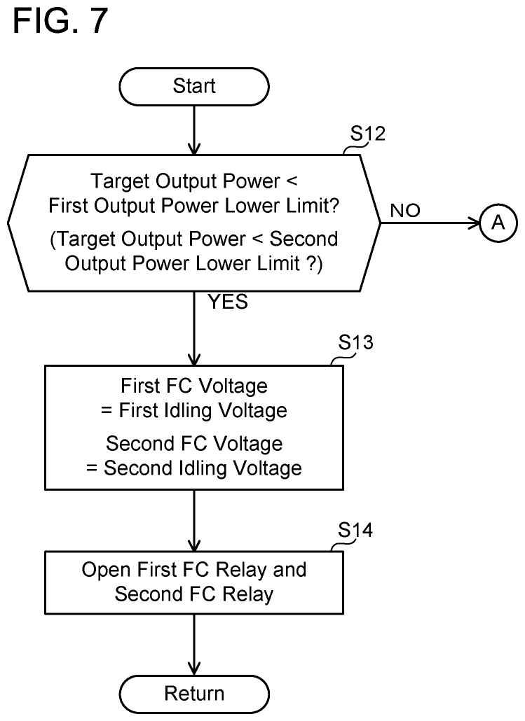

The controller 205 controls the FC stacks 11a, 11b so that degradation of the FC stacks 11a, 11b does not progress. FIGS. 7-9 illustrate a flowchart of a process executed by the controller 205. In the following explanations and FIGS. 7-9, the output voltage of the first FC stack 11a will be referred to as a first FC voltage, and the output voltage of the second FC stack 11b will be referred to as a second FC voltage.

The controller 205 compares the target output power inputted by the user with the first output power lower limit (step S12). As described above, the first output power lower limit is assumed to be lower than or equal to the second output power lower limit. Therefore, when the target output power is lower than the first output lower limit, the target output power is lower than the second output power lower limit.

When the target output power is lower than each of the first output power lower limit and the second output power lower limit (step S12: YES), the controller 205 controls first FC stack 11a to match the first FC voltage with the first idling voltage, and controls the second FC stack 11b to match the second FC voltage with the second idling voltage (step S13). As described in the first and second embodiments, the controller 205 drives the step-up converter 12a (12b) until the output voltage of the FC stack 11a (11b) decreases to the idling voltage which is lower than the battery voltage (output voltage of the battery unit 3). The power of the FC stack 11a (11b) is supplied to the battery 3a, and the first FC voltage and the second FC voltage decrease. When the output voltages of the FC stacks 11a, 11b decrease to the respective idling voltages, the controller 205 stops the step-up converters 12a, 12b, and opens the first FC relay 15a and the second FC relay 15b (step S14).

Since the FC relays 15a, 15b are opened, the output from the FC stacks 11a, 11b do not flow through the output terminals 4. The power of the battery unit 3 is outputted from the output terminals 4. Even when the FC relay 15a (15b) is closed, power does not flow from the FC stack 11a (11b) to the output terminals 4. This is because the output voltage of the FC stack 11a (11b) is set to the first idling voltage (the second idling voltage) and the first idling voltage (the second idling voltage) is lower than the voltage of the battery unit 3. The reason the FC relays 15a, 15b are opened is to ensure that the output from the FC stacks 11a, 11b is stopped.

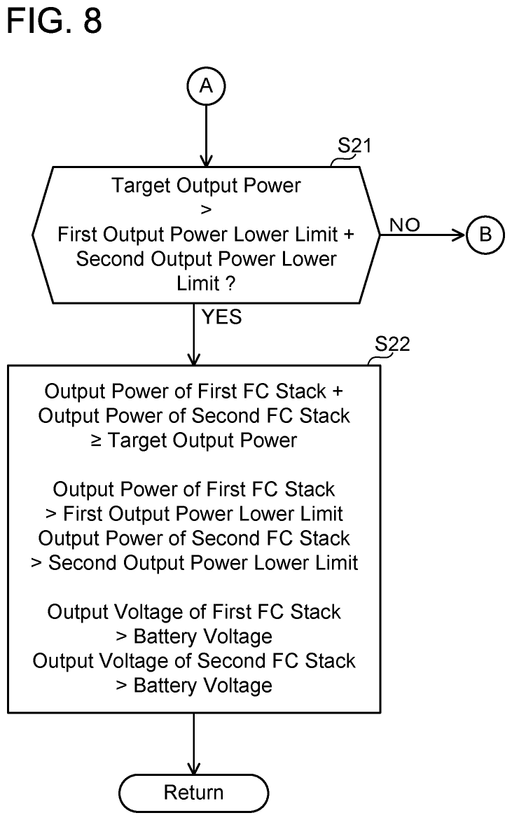

In step S12, when the target output power is higher than the first output power lower limit, the controller 205 proceeds to the process of step S21 in FIG. 8.

In step S21, the controller 205 compares the target output power with the total (total lower limit) of the first output power lower limit and the second output power lower limit. When the target output power is higher than the total lower limit. the controller 205 controls the FC stacks 11a, 11b so that the total of the output powers of the FC stacks 11a, 11b becomes equal to or higher than the target output power. At this point, the controller 205 further controls the FC stacks 11a, 11b so that the output power of the first FC stack 11a exceeds the first output power lower limit and the output power of the second FC stack 11b exceeds the second output power lower limit. The controller 205 further controls the FC stacks 11a, 11b so that output voltage of each of the FC stacks 11a, 11b (output voltage of each of the step-up converters 12a, 12b) exceeds the voltage of the battery unit 3 (step S22).

Since the output voltage of each of the step-up converters 12a. 12b is higher than the voltage of the battery unit 3, the power flows from the FC stacks 11a, 11b to the output terminals 4.

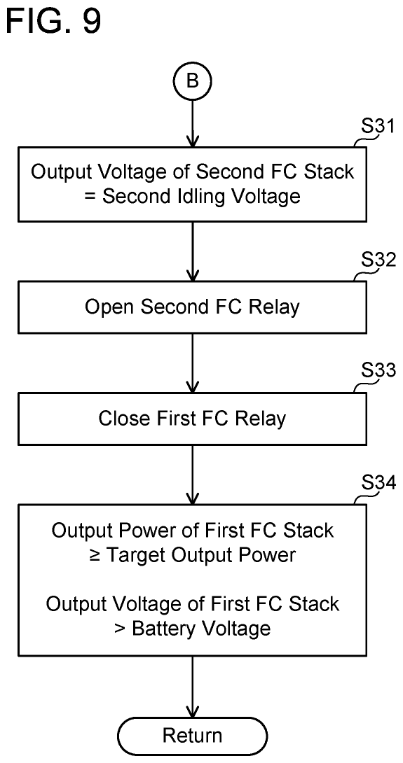

In the process of step S21, when the target output power is lower than the total lower limit, the controller 205 proceeds to the process of step S31 of FIG. 9.

When the target output power is higher than the first output power lower limit (step S12: NO) and is lower than the total lower limit (step S21: NO), the controller 205 controls the FC stacks 11a, 11b so that the power is outputted from the first FC stack 11a but not outputted from the second FC stack 11b. Specifically. the controller 205 first controls the second FC stack 11b to maintain the output voltage of the second stack 11b at the second idling voltage (step S31). As described above, the controller 205 drives the step-up converter 12b until the output voltage of the second FC stack 11b decreases to the second idling voltage (output voltage of the step-up converter 12b>battery voltage). The power of the second FC stack 11b flows to the battery 3a of the battery unit 3 and the voltage of the second FC stack 11b decreases. When the output voltage of the second FC stack 11b has decreased to the second idling voltage. the controller 105 stops the step-up converter 12b and opens the second FC relay 15b (step S32).

Next, the controller 205 closes the first FC relay 15a (step S33). The controller 205 controls the first FC stack 11a so that the output power of the first FC stack 11a becomes higher than or equal to the target output power and the output voltage of the first FC stack 11b (output voltage of the step-up converter 12a) exceeds the voltage of the battery unit 3 (step S34).

Since the output voltage of the second FC stack 11b is maintained at the second idling voltage and the second idling voltage is lower than the voltage of the battery unit 3, the power does not flow from the second FC stack 11b to the output terminals 4. Since the output voltage of the second FC stack 11b is maintained at the second idling voltage, degradation of the plurality of single cells in the second FC stack 11b can be mitigated.

On the other hand, since the output voltage of the first FC stack 11a (output voltage of the step-up converter 12a) is higher than the voltage of the battery unit 3, the output power of the first FC stack 11a is outputted from the output terminals 4. With the first FC stack 11a, the target output power is outputted from the output terminals 4.

As explained above, the fuel cell system of the embodiment is controlled so that the output voltage of the FC unit (FC stack) becomes greater than or equal to the idling voltage, as a result of which degradation of the plurality of single cells can be mitigated.

Points to be noted regarding the technique explained in the embodiment w % ill be described. In the third embodiment, the two FC stacks 11a, 11b are connected to the output terminals 4. Three or more FC stacks may be connected to the output terminals 4 in parallel.

The FC system of the embodiment maintains the output voltage of the FC stack at the idling voltage without stopping the FC unit (FC stack) even when the target output voltage is low. The FC system of the embodiment can reduce the repetitive activation and stop, as a result of which the degradation can be mitigated. To lower the output voltage of the FC stack, a process to reduce an amount of oxygen (air) to be supplied to the FC stack is suitable.

The degradation can be mitigated by maintaining the output voltage of the FC stack at the idling voltage, however, the degradation relatively progresses as compared to the FC stack outputting large current. When the plurality of FC stacks is connected in parallel and output voltage of at least of the FC stacks is to be maintained at the idling voltage, it is preferable to select FC stack(s) having low output characteristics. Progression of degradation of the plurality of FC stacks can be equalized. Here, “having low output characteristics” means the FC stack(s) of which output voltage is the lowest when each of the plurality of FC stacks outputs the same electric current.

As described above, even if “target output power”, “output power of the FC unit”, “output power lower limit” in the description of the embodiment are renamed “target output current”, “output current of the FC unit”, “output current lower limit”, respectively, they are technically equivalent.

The FC relays 15, 15a, 15b are not indispensable, however, they are useful in ensuring that the output of the FC unit of which output voltage is maintained at the idling voltage is stopped. When the step-up converter is a type which uses one or more transformers, stopping the step-up converter electrically separates the opposite ends of the step-up converter, as a result of which the FC relays will be unnecessary.

The FC unit of the FC system of the embodiment includes the FC stack and the step-up converter. The step-up converter may not be included. However, when the FC unit includes the step-up converter, the following benefits are obtained. By increasing the output voltage of the FC unit to a value higher than the voltage of the battery unit by using the step-up converter, the power of the FC stack can be transferred to the battery unit. With this transfer of the electric power, the output voltage of the FC stack can quickly be decreased to the idling voltage.

The battery unit of the FC system of the embodiment includes the battery and the voltage converter. The voltage converter may not be included.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present specification or drawings provide technical utility either independently or through various combinations. The present disclosure is not limited to the combinations described at the time the claims are filed. Further, the purpose of the examples illustrated by the present specification or drawings is to satisfy multiple objectives simultaneously, and satisfying any one of those objectives gives technical utility to the present disclosure.

What is claimed is:

1. A fuel cell system comprising:
a fuel cell unit connected to an output terminal;
a battery unit connected to the fuel cell unit in parallel: and
a controller configured to control the fuel cell unit to maintain an output voltage of the fuel cell unit at an idling voltage which is higher than zero and lower than an output voltage of the battery unit when target output power for the fuel cell system is lower than an output power lower limit set for the fuel cell unit.

2. The fuel cell system of claim 1, wherein the idling voltage is equal to or higher than a voltage defined by multiplying a predetermined maintenance voltage of a single cell in a fuel cell stack of the fuel cell unit by a number of cells in the fuel cell stack.

3. The fuel cell system of claim 1, wherein the fuel cell unit comprises:
a fuel cell stack; and
a step-up converter configured to step up the output voltage of the fuel cell stack, and
when the target output power is higher than the output power lower limit, the controller is configured to:
control the fuel cell unit so that the output power of the fuel cell unit becomes equal to or higher than the target output power; and
control the step-up converter so that the output voltage of the fuel cell unit exceeds the output voltage of the battery unit.

4. The fuel cell system of claim 1, wherein
the fuel cell unit comprises a first fuel cell stack and a second fuel cell stack connected in parallel,
a first output power lower limit is set for the first fuel cell stack,
a second output power lower limit is set for the second fuel cell stack, and
the controller is configured to:
(1) when the target output power is higher than the first output power lower limit and lower than a total of the first and second output power lower limits,
control the first fuel cell stack so that the output power of the first fuel cell stack becomes equal to or higher than the target output power, and
control the second fuel cell stack to maintain the output voltage of the second fuel cell stack at a second idling voltage which is higher than zero and lower than the output voltage of the battery unit;
(2) when the target output power is higher than the total of the first and second output power lower limits,
control the first and second fuel cell stack so that the output power of the first fuel cell stack exceeds the first output power lower limit, the output power of the second fuel cell stack exceeds the second output power lower limit, and total output power of the first and second fuel cell stacks becomes equal to or higher than the target output power; and
(3) when the target output power is lower than each of the first and second output power lower limits,
control the first fuel cell stack to maintain the output voltage of the first fuel cell stack at a first idling voltage which is higher than zero and lower than the output voltage of the battery unit: and control the second fuel cell stack to maintain the output voltage of the second fuel cell unit at the second idling voltage.

5. The fuel cell system of claim 4, wherein the first output power lower limit is equal to or lower than the second output power lower limit.
